(19) United States
(12) Patent Application Publication
(10) Pub. No.: US 2024/0383066 A1
(43) Pub. Date: Nov. 21, 2024

(54) HIGH-PRECISION LASER TRIGGER SYSTEM AND HIGH-PRECISION LASER TRIGGER METHOD USING THE SAME

(71) Applicant: DIT CORP., Hwaseong-si (KR)

(72) Inventors: Boo Yeon CHOI, Seongnam-si (KR); Young Hoon CHOI, Hwaseong-si (KR); Hyung Sun LEE, Hwaseong-si (KR)

(21) Appl. No.: 18/668,031

(22) Filed: May 17, 2024

(30) Foreign Application Priority Data
May 18, 2023 (KR) 10-2023-0064664

(51) Int. Cl. B23K 26/04; B23K 26/00; B23K 26/08; B23K 103/00

(52) U.S. Cl. CPC B23K 26/04; B23K 26/0006; B23K 26/0853; B23K 2103/56

(57) ABSTRACT

A high-precision laser trigger system according to one embodiment of the present disclosure includes a stage on which an object is mounted, a trigger generator configured to generate a trigger signal according to a time-based mode and a position-based mode, a laser configured to emit laser light when the trigger signal is input, a motion controller configured to control the stage and the trigger generator, and a control device configured to identify coordinates of the stage, which places the object in a light-emitting position of the laser in the position-based mode, and transmit coordinate information including the coordinates and a mode change signal for changing a mode between the time-based mode and the position-based mode to the motion controller.

### CROSS-REFERENCE TO RELATED APPLICATION

This application claims priority to and the benefit of Korean Patent Application No. 10-2023-0064664, filed on May 18, 2023, the disclosure of which is incorporated herein by reference in its entirety.

### BACKGROUND

### 1. Field

The present disclosure relates to a high-precision laser trigger system and a high-precision laser trigger method using the same.

### 2. Discussion of Related Art

Laser processing technology is expanding from traditional manufacturing fields such as steel and automobiles to semiconductor, display, and medical device fields, in which ultra-high-speed and ultra-precision processing technology is required.

The main challenge in achieving more precise laser processing lies in ensuring that a laser trigger system is equipped with a trigger generator that triggers a laser, and a trigger signal is generated and input to the laser at a correct light-emitting position while accurately synchronizing with a cycle required by a laser system.

In particular, in the case of a pumped laser, in order to emit laser light with a certain energy to a target such as a wafer, a trigger signal may need to be generated/input continuously even outside a processing period.

In this case, errors may occur when entering a processing period from a non-processing period, or errors may occur in a triggering cycle or position due to a communication delay during the generation and input of a trigger signal.

Accordingly, there is a need for a method that enables laser processing to be performed accurately in accordance with the cycle and position required by a laser system.

The disclosure of this section is to provide background information relating to the present disclosure. Applicant does not admit that any information contained in this section constitutes prior art.

### SUMMARY

The present disclosure is directed to providing a high-precision laser trigger system that performs laser processing more precisely and accurately, and a high-precision laser trigger method using the same.

According to an aspect of the present disclosure, there is provided a high-precision laser trigger system including a stage on which an object is mounted, a trigger generator configured to generate a trigger signal according to a time-based mode and a position-based mode, a laser configured to emit laser light when the trigger signal is input, a motion controller configured to control the stage and the trigger generator, and a control device configured to identify coordinates of the stage, which places the object in a light-emitting position of the laser in the position-based mode, and transmit coordinate information including the coordinates and a mode change signal for changing a mode between the time-based mode and the position-based mode to the motion controller, wherein the motion controller is configured to control the trigger generator to generate the trigger signal every cycle in the time-based mode, upon receiving the mode change signal, control the stage to accelerate so that a moving speed of the stage reaches a target speed and locate at a starting coordinate of the coordinates, switch the mode to the position-based mode when the stage is located at the starting coordinate and control the trigger generator to generate the trigger signal whenever the stage is located at each of the coordinates while moving at the target speed, and, when the stage reaches an end coordinate among the coordinates, control the stage to decelerate upon receiving the mode change signal.

The motion controller may calculate a position error caused by a communication delay using the target speed and a communication delay time and corrects the coordinates.

The control device may identify the target speed of the stage based on the cycle of the trigger signal and a light-emitting interval of the laser.

The motion controller may identify a position of the stage based on an encoder signal received from the stage.

The control device may set an acceleration time, during which the stage is accelerated, and a deceleration time, during which the stage is deaccelerated, to be a multiple of the cycle of the trigger signal.

The motion controller, after accelerating the stage, may control the stage to move to a next starting coordinate.

The motion controller may perform synchronization in the position-based mode while the stage moves to the starting coordinate.

According to another aspect of the present disclosure, there is provided a high-precision laser trigger method performed by a high-precision laser trigger system, the high-precision laser trigger method including controlling a trigger generator to generate a trigger signal every cycle in a time-based mode, controlling, upon receiving a mode change signal to change a mode from the time-based mode to a position-based mode, a stage on which an object is mounted to locate at a starting coordinate among coordinates of the stage by accelerating the stage so that a moving speed of the stage reaches a target speed, switching the mode to the position-based mode when the stage is located at the starting coordinate and controlling the trigger generator to generate the trigger signal whenever the stage is located at each of the coordinates while moving at the target speed, and when the stage reaches an end coordinate among the coordinates, controlling the stage to decelerate upon receiving a mode change signal for changing the mode from the position-based mode to the time-based mode.

The high-precision laser trigger method may further include, before the controlling of the stage to be located at the starting coordinate, identifying the coordinates of the stage for placing the object at a light-emitting position of the laser in the position-based mode.

The identifying of the coordinates of the stage may include calculating a position error caused by a communication delay using the target speed and a communication delay time and correcting the coordinates.

The high-precision laser trigger method may further include, before the controlling of the stage to be located at the starting coordinate, identifying the target speed of the stage based a cycle of the trigger signal and a light-emitting interval of the laser.

The high-precision laser trigger method may further include identifying a position of the stage based on an encoder signal received from the stage.

The high-precision laser trigger method may further include setting an acceleration time, during which the stage is accelerated, and a deceleration time, during which the stage is deaccelerated, to be a multiple of the cycle of the trigger signal.

The high-precision laser trigger method may further include, after the controlling of the stage to decelerate, moving the stage to a next starting coordinate.

The controlling of the stage to be located at the starting coordinate may include performing synchronization in the position-based mode while the stage moves to the starting coordinate.

### BRIEF DESCRIPTION OF THE DRAWINGS

The above and other aspects, features, and advantages of the present disclosure will become more apparent to those of ordinary skill in the art by describing embodiments thereof in detail with reference to the accompanying drawings, in which:

FIG. 1 is a schematic diagram illustrating a high-precision laser trigger system according to one embodiment of the present disclosure;

FIG. 2 is a diagram illustrating an operation flowchart of the high-precision laser trigger system according to one embodiment of the present disclosure;

FIG. 3 is a diagram illustrating a signal chart of the high-precision laser trigger system according to one embodiment of the present disclosure;

FIG. 4 is a diagram illustrating an operation when the high-precision laser trigger system according to one embodiment of the present disclosure is applied to a wafer; and

FIG. 5 is a diagram illustrating error correction of the high-precision laser trigger system according to one embodiment of the present disclosure.

### DETAILED DESCRIPTION OF EMBODIMENTS

Hereinafter, embodiments of the present disclosure will be described in detail with reference to the accompanying drawings. The detailed description set forth below in connection with the accompanying drawings is intended to describe the embodiment of the present disclosure and is not intended to represent the only implementation in which the present disclosure may be implemented. In order to clearly describe the present disclosure in the drawings, not related with a description is omitted, and the same reference numerals may be used for identical or similar components throughout the specification.

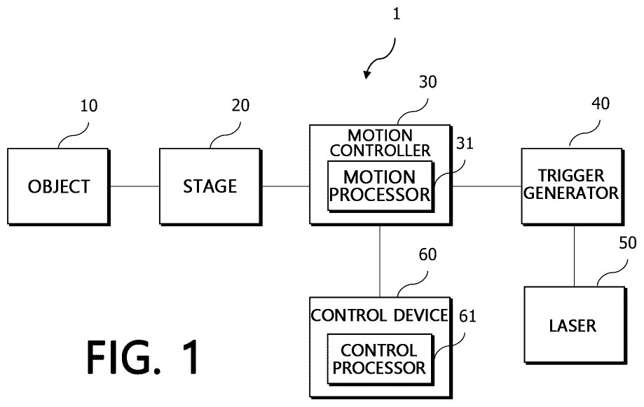

FIG. 1 is a schematic diagram illustrating a high-precision laser trigger system according to one embodiment of the present disclosure.

Referring to FIG. 1, a high-precision laser trigger system 1 (hereinafter also referred to as a “system 1”) according to one embodiment of the present disclosure includes an object 10, a stage 20, a motion controller 30, a trigger generator 40, a laser 50, and a control device 60.

The object 10 is a component subject to laser processing and applicable to various applications such as semiconductor wafers, displays, and the like.

The stage 20 is a component on which the object 10 is mounted and transported, which may be a multi-axis stage (an XY stage or XYZ stage). The method by which the stage 20 is moved is not limited to any one method, and various methods are applicable. The stage 20 includes an encoder, and thus may continuously provide position information of the stage 20 to the motion controller 30.

The motion controller 30 is a device that controls the stage 20 and the trigger generator 40. Specifically, the motion controller 30 moves the stage 20 such that the object 10 is disposed at a light-emitting position of the laser 50, and monitors the position of the stage 20 to control the trigger generator 40 such that the laser 50 emits laser light to a predetermined position.

The motion controller 30 includes a processor (hereinafter referred to as a motion processor 31), and the motion processor 31 may execute software, such as a program, to control at least one or more other components of the motion controller 30 (e.g., hardware or software components), and may perform various data processing or computation.

The motion processor 31 may communicate wired or wirelessly with the stage 20, the trigger generator 40, and the control device 60 to receive or transmit necessary information therefrom or thereto. To this end, the motion controller 30 may include a separate communication unit. Hereinafter, the operation of the motion controller 30 is considered to be performed by the motion processor 31.

The trigger generator 40 is a device that generates a trigger signal. The system 1 according to one embodiment of the present disclosure operates by switching a mode between a time-based mode and a position-based mode. The time-based mode is a mode in which the system 1 generates a trigger signal based on a time (cycle) in a preparation period before the system 1 performs processing, and the position-based mode is a mode in which the system 1 generates a trigger signal based on a position of the stage 20 in a period in which the system 1 performs processing. Accordingly, the trigger generator 40 may generate a trigger signal according to the time-based mode and the position-based mode.

The laser 50 is fixedly located in the system 1 and emits laser light to the object 10 upon receiving the trigger signal from the trigger generator 40. At this point, the laser 50 may be a pump laser, but the present disclosure is not limited thereto, any type of laser may be employed as long as it is implemented to emit laser light upon receiving a trigger signal.

The control device 60 is a device that controls overall operations of the components in the system 1 and may be implemented as a computer, a server, or the like.

The control device 60 includes a processor (hereinafter referred to as a control processor 61), and the control processor 61 may execute software, such as a program, to control at least one or more other components of the control device 60 (e.g., hardware or software components), and may perform various data processing or computation.

The control processor 61 may communicate wired or wirelessly with the stage 20, the motion controller 30, and the trigger generator 40 to receive or transmit necessary information therefrom or thereto. To this end, the control device 60 may include a separate communication unit. Hereinafter, the operation of the control device 60 is considered to be performed by the control processor 61.

The control device 60 identifies coordinates to which the stage 20 is to be moved. The control device 60 transmits coordinate information including the identified coordinates and a mode change signal for changing the mode between the time-based mode and the position-based mode to the motion controller 30. Meanwhile, the motion controller 30 may move the stage 20 based on the coordinate information and control the trigger generator 40 based on the position of the stage 20.

According to one embodiment of the present disclosure, the system 1 is required to continuously generate/input a trigger signal in periods other than a period in which processing is performed to emit laser light with a certain energy to the object 10 (in the present disclosure, refers to a period in which the system 1 operates in the position-based mode).

At this point, errors may occur in a triggering period or a light-emitting position in the process of generating/inputting the trigger signal due to the process of switching the mode between the time-based mode and the position-based modes or due to a communication delay.

The present disclosure proposes the high-precision laser trigger system 1 capable of reducing errors occurring during mode switching by introducing a synchronization period between modes and reducing the errors by correcting coordinates in consideration of a communication delay, and a high-precision laser trigger method using the same.

Hereinafter, the operation of the system 1 according to one embodiment of the present disclosure will be described in detail with reference to the drawings.

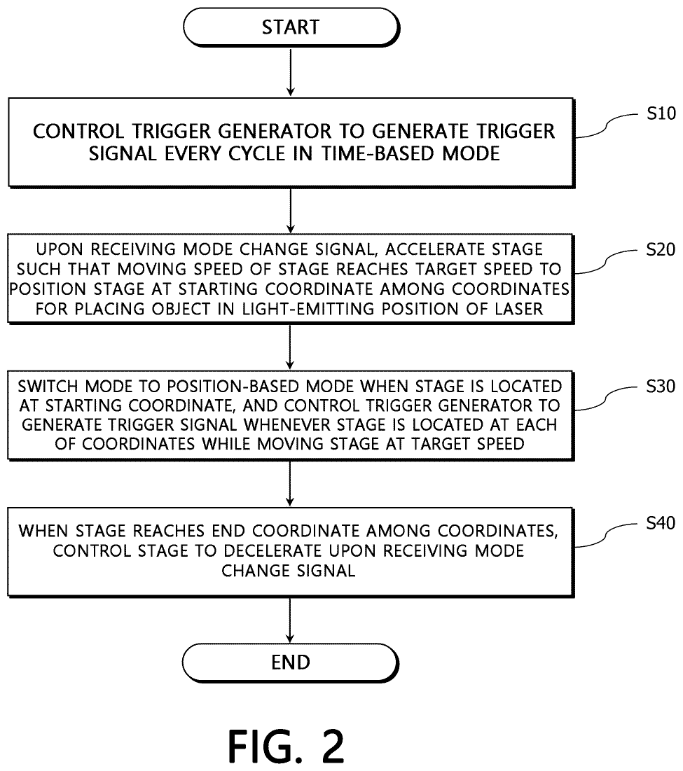

FIG. 2 is a diagram illustrating an operation flowchart of the high-precision laser trigger system according to one embodiment of the present disclosure. Hereinafter, operations will be described based on the motion controller 30.

According to one embodiment of the present disclosure, the motion controller 30 controls the trigger generator 40 to generate a trigger signal every cycle in a time-based mode (S10).

As described above, the time-based mode is a mode in which the system 1 generates a trigger signal based on a time (cycle) in a preparation period before performing processing. At this point, the cycle may be determined according to the performance of the laser 50. Hereinafter, the cycle is referred to as a cycle of the trigger signal.

In the time-based mode, the laser 50 does not actually process the object 10, but the laser 50 outputs laser light every cycle to maintain a constant energy of the laser light, thereby improving the quality of processing. However, a shutter is provided inside or outside the laser 50 to block the laser light from being emitted to unnecessary areas in the time-based mode.

According to one embodiment of the present disclosure, upon receiving a mode change signal, the motion controller 30 accelerates the stage 20 such that a moving speed of the stage 20 reaches a target speed, thereby positioning the stage 20 at a starting coordinate among the coordinates of the stage (S20).

In general, when the object 10 is loaded onto the stage 20, the position of the object 10 may be slightly misaligned. The control device 60 performs vision alignment on the object 10 and identifies the coordinates of the stage 20 to position the object 10 at the light-emitting position of the laser 50. The control device 60 may identify the coordinates of the stage 20 in consideration of the size of the laser 50 (or a light-emitting interval of the laser 50). For example, when the laser 50 has a square shape with a size of 20 mm*20 mm, the light-emitting interval of the laser may be 20 mm. In addition, the control device 60 may set an overall light-emitting path, by taking into account the shape of the object 10. The coordinates of stage 20 are determined according to the light-emitting path.

The motion controller 30 receives the coordinate information including the coordinates of the stage 20 and the mode change signal from the control device 60. The mode change signal is a signal for changing the mode from the time-based mode to the position-based mode or from the position-based mode to the time-based mode.

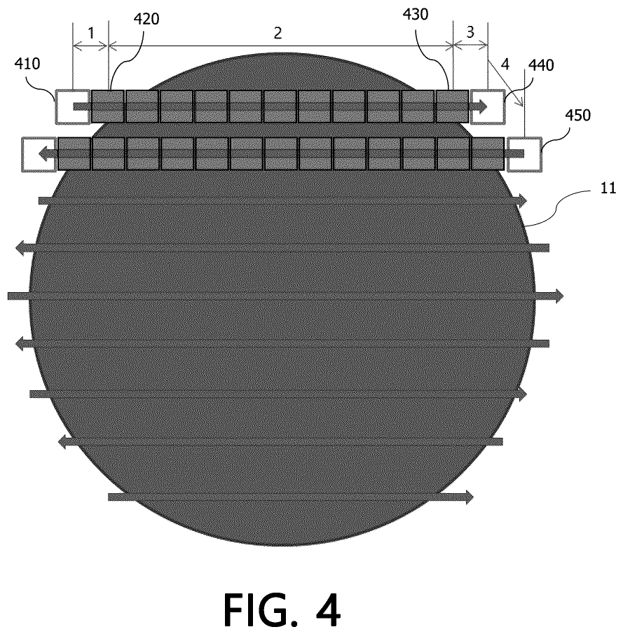

When a processing process is divided into several periods, the starting coordinate is a position at which the laser 50 first emits laser light to the object 10 in each period. For example, when the object 10 is a wafer and is processed from left to right in a transverse direction of the wafer, the leftmost coordinate of an area in which the laser emits light to the wafer becomes the starting coordinate. In this regard, a detailed description will be provided with reference to FIG. 4.

At this point, a processing direction is not limited to any one direction, and the control device 60 or the motion controller 30 may actively select paths. In addition, it is obvious that an operator may manually select the paths by operating the control device 60 or the motion controller 30.

In addition, when the mode change signal to change the mode from the time-based mode to the position-based mode is received, the stage 20 should or may need to be located at a previous coordinate of the starting coordinate. The previous coordinate means a position from which the stage 20 can reach the starting coordinate when accelerating the stage 20 (hereinafter referred to as accelerating the stage 20 at a constant acceleration) in the processing direction to reach the target speed. In general, the previous coordinate is offset from the starting coordinate by a margin equal to the light-emitting interval of the laser. The control device 60 may identify the previous coordinate, and transmit the previous coordinate together with the coordinate information and the mode change signal to the motion controller 30.

According to one embodiment of the present disclosure, the motion controller 30 may monitor the position of the stage 20 and move the stage 20 to the previous coordinate.

The control device 60 may identify the target speed of the stage 20 based on the cycle of the trigger signal and the light-emitting interval of the laser. For example, when the light-emitting interval of the laser is 20 mm and the cycle of the trigger signal is 5 Hz (0.2 s), the target speed of the stage 20 becomes 100 mm/s.

The motion controller 30 accelerates the stage 20 in the processing direction to reach the target speed. At this point, the motion controller 30 may accelerate the stage 20 at a constant acceleration. The control device 60 may set an acceleration time, during which the stage 20 is accelerated, to be a multiple of the cycle of the trigger signal. This is to maintain the cycle of the trigger signal even during the synchronization period.

Meanwhile, the acceleration period is the period before the mode is completely changed from the time-based mode to the position-based mode, and is also referred to as the synchronization period. The motion controller 30 performs a synchronization operation during the synchronization period, such as eliminating errors between signals or executing processes to switch to the position-based mode.

According to one embodiment of the present disclosure, the motion controller 30 switches to the position-based mode when the stage 20 is located at the starting coordinate, and controls the trigger generator 40 to generate a trigger signal each time the stage 20 is located at each of the coordinates while moving the stage 20 at the target speed (S30).

When the stage reaches the target speed, the motion controller 30 controls the stage 20 to move at a constant speed in the position-based mode.

When the trigger generator 40 generates a trigger signal at each of the coordinates of the stage 20, the laser 50 receives the trigger signal and emits laser light at the corresponding coordinate on the object 10 on the object 10.

According to one embodiment of the present disclosure, when the stage 20 reaches an end coordinate among the coordinates, the motion controller 30 decelerates the stage 20 upon receiving the mode change signal (S40).

Similarly, when the processing process is divided into several periods, the end coordinate is a position at which the laser 50 finally emits laser light to the object 10 in each period. For example, when the object 10 is a wafer and is processed from left to right in the transverse direction of the wafer, the rightmost coordinate of the area of the wafer to which the laser is emitted becomes the end coordinate. In this regard, a detailed description will be provided with reference to FIG. 4.

The control device 60 may transmit the mode change signal to the motion controller 30 when the stage 20 reaches the end coordinate. Alternatively, when the end coordinate is reached, the motion controller 30 may generate a mode change signal at a falling edge of the trigger signal.

At this point, the mode change signal is a signal for changing the mode from the position-based mode back to the time-based mode.

Meanwhile, similar to the acceleration period described above, a deceleration period is a period before the mode is completely changed from the position-based mode to the time-based mode, and is also referred to the synchronization period. The motion controller 30 performs a synchronization operation during the synchronization period, such as eliminating errors between signals or executing processes to switch to the time-based mode.

When the processing is completed, the motion controller 30 decelerates the stage 20 so that the moving speed of the stage 20 is zero (the stage is stopped).

When the processing is not completed, as the stage 20 needs to be moved to a position for next processing, the motion controller 30 decelerates the moving speed to a certain speed. The motion controller 30 decelerates the stage 20 at a certain deceleration rate.

The process described in S10 to S40 of FIG. 2 is one sequence of the processing process of the object 10. Depending on the size or shape of the object 10, a plurality of sequences may be performed to complete the processing process.

The control device 60 may transmit position information (coordinate information) for next processing to the motion controller 30. Meanwhile, the control device 60 may identify and transmit coordinate information of the stage 20 for processing the entire object 10, but is not limited thereto, and may transmit the coordinate information by sequence or in real time.

According to one embodiment of the present disclosure, laser light of the same energy may be emitted at an exact position on an object through mode switching in processing/non-processing periods, thereby improving the quality of processing.

According to one embodiment of the present disclosure, when changing the mode between modes, a synchronization period is provided to prepare for switching to the changed mode, thereby eliminating errors between signals.

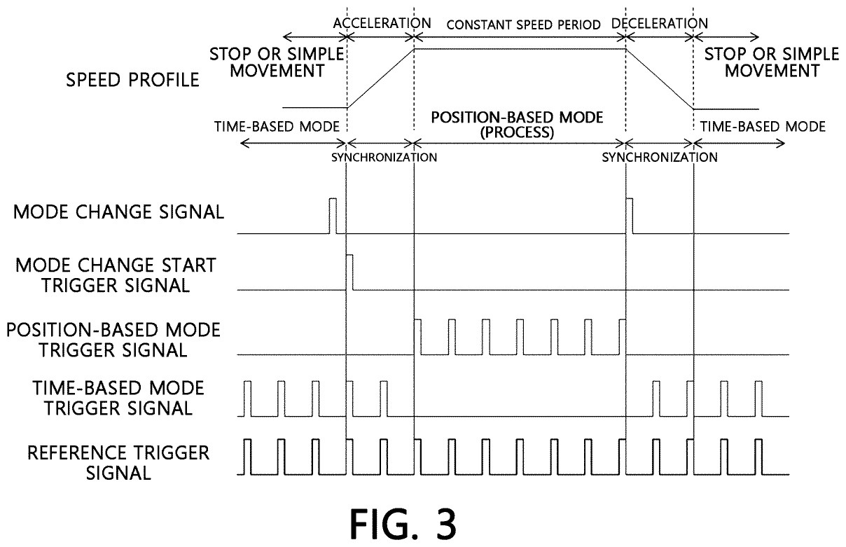

FIG. 3 is a diagram illustrating a signal chart of the high-precision laser trigger system according to one embodiment of the present disclosure.

The signal chart illustrates the content previously described with reference to FIG. 2, and thus the overlapping content is referred to FIG. 2.

Referring to FIG. 3, a trigger signal in the time-based mode (including the synchronization period) and a trigger signal in the position-based mode are both generated at the same cycle as a reference trigger signal.

First, when the stage 20 is stationary or simply moving in position (an idle state), the trigger signal is generated at a cycle of 5 Hz (0.2 seconds) in the time-based mode.

The control device 60 transmits a mode change signal and position-based stage coordinates to the motion controller 30. The mode change signal may be generated when the stage 20 is at the previous coordinate of the starting coordinate.

After receiving the mode change signal from the control device 60, the motion controller 30 generates a mode change start trigger signal and controls the stage 20 to accelerate.

An acceleration time of the stage 20 may be set to be a multiple of the cycle of the trigger signal, and in FIG. 3, the acceleration time is set to twice the cycle of the trigger signal, resulting in an acceleration time of 0.4 seconds. While the stage 20 is accelerating, the trigger generator 40 continues to be triggered by the time-based mode trigger signal. As described above, the acceleration period is the synchronization period, and the motion controller 30 changes from the time-based mode to the position-based mode and performs synchronization. The coordinates received from the control device 60 may be input to the motion controller 30.

After finishing accelerating the stage 20 and the synchronization, the motion controller 30 is switched to the position-based mode and controls the trigger generator 40 to generate a trigger signal while moving the stage 20 at a constant speed when the stage 20 reaches the input coordinate.

The motion controller 30 receives the mode change signal again at the falling edge of the trigger signal when the stage 20 reaches the last of the input coordinates.

Upon receiving the mode change signal, the motion controller 30 decelerates the stage 20. Likewise, a deceleration time is set to twice the cycle of the trigger signal, resulting in a deceleration time of 0.4 seconds. The motion controller 30 performs the synchronization by changing the mode from the position-based mode to the time-based mode.

When the deceleration is completed, the mode is changed to the time-based mode and the trigger signal is generated at a cycle of 5 Hz (0.2 seconds).

FIG. 4 is a diagram illustrating an operation when the high-precision laser trigger system according to one embodiment of the present disclosure is applied to a wafer.

FIG. 4 illustrates a specific operation process of the system 1 when the object 10 is a wafer 11. Likewise, the content that overlaps that described with reference to FIGS. 2 and 3 will be derived from the previously described content.

As described above, a processing direction/processing path of the wafer 11 may be set in various ways, and in the case of FIG. 4, the processing path is set in a zigzag direction, extending from left to right/from right to left across the transverse direction of the wafer 11. At this point, processing is performed one line at a time, and the one line is considered to be one sequence.

The control device 60 identifies coordinates at which the stage should or may need to be located in consideration of the shape of the wafer 11, the light-emitting interval of the laser, the position of the laser, and the like.

The motion controller 30 moves the stage 20 to a previous coordinate 410 using the coordinate information. The previous coordinate 410 is a previous coordinate of a starting coordinate 420 of the stage 20, as previously described in relation to S20 of FIG. 2.

When the stage 20 is located at the previous coordinate 410, the motion controller 30 controls the stage 20 to accelerate according to the mode change signal to position the stage 20 at the starting coordinate 420 (1: the acceleration period the synchronization period).

The motion controller 30 controls the trigger generator 40 to emit laser light for each predetermined coordinate while moving the stage 20 at a constant speed from the starting coordinate 420 to an end coordinate 430 (2: a constant speed period and the position-based mode).

When the motion controller 30 receives the mode change signal again at the end coordinate 430, the motion controller 30 controls the stage 20 to decelerate (3: the deceleration period=the synchronization period).

As a result, the stage 20 may be located at a coordinate 440 and moved to a previous coordinate 450 of a next sequence (4: a stop or simple movement period and the time-based mode).

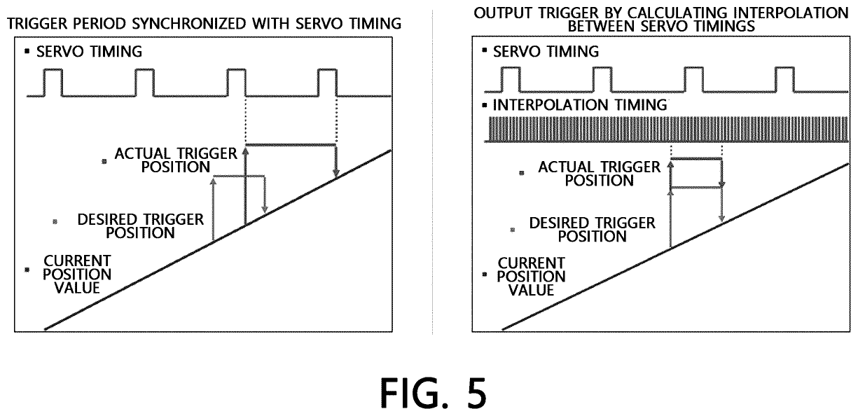

FIG. 5 is a diagram illustrating error correction of the high-precision laser trigger system according to one embodiment of the present disclosure.

According to one embodiment of the present disclosure, a communication delay may occur in a process in which an encoder signal is input to the motion controller 30 from the stage 20 and a trigger signal is generated and output from the trigger generator 40 in the position-based mode and input to the laser 50. That is, errors may occur because the cycle of the trigger signal and a cycle of the encoder signal do not exactly match.

The communication delay is an intrinsic value of the system, and remains unchanged even when the speed changes. Accordingly, the motion controller 30 may calculate a position error caused by the communication delay and correct the coordinates. Specifically, the motion controller 30 may calculate the position error caused by the communication delay using the target speed and a communication delay time.

For example, when the cycle of the trigger signal is 5 Hz and the light-emitting interval of the laser is 20 mm, the target speed becomes 100 mm/s. When the communication delay time is 1 ms, a position error of 0.1 mm is caused by the communication delay.

In this case, even when the laser 50 emits light at the same X-axis position, a position error of up to 0.2 mm up or down may occur depending on a moving direction of the object 10.

The motion controller 30 may calculate an error time based on the moving speed (target speed) and the communication delay time of the object 10 and apply a correction value according to the moving direction.

Alternatively, as shown in FIG. 5, a trigger position may be precisely corrected by multiplying the cycle with a resolution of 10 nsec in the trigger generator 40.

According to one embodiment of the present disclosure, the quality of processing may be further improved by correcting errors caused by a communication delay.

According to one embodiment of the present disclosure, laser light of the same energy can be emitted at an exact position on an object through mode switching in processing/non-processing periods, thereby improving the quality of processing.

According to one embodiment of the present disclosure, when changing between modes, a synchronization period can be provided to prepare for switching to the changed mode, thereby eliminating errors between signals.

According to one embodiment of the present disclosure, the quality of processing can be further improved by correcting errors caused by a communication delay.

Logical blocks, modules or units described in connection with embodiments disclosed herein can be implemented or performed by a computing device having at least one processor, at least one memory and at least one communication interface. The elements of a method, process, or algorithm described in connection with embodiments disclosed herein can be embodied directly in hardware, in a software module executed by at least one processor, or in a combination of the two. Computer-executable instructions for implementing a method, process, or algorithm described in connection with embodiments disclosed herein can be stored in a non-transitory computer readable storage medium.

Although the disclosure hereof is detailed and exact to enable those skilled in the art to practice embodiments, the embodiments disclosed herein are merely examples of the disclosure, which may be embodied in other specific structure and/or configuration. While various embodiments have been described, the details may be changed without departing from the disclosure, which is defined by the claims.

It should be appreciated that in the above description of embodiments, various features are sometimes grouped together in a single embodiment, figure, or description thereof for the purpose of streamlining the disclosure and aiding in the understanding of one or more of the various aspects. This method of disclosure, however, is not to be interpreted as reflecting an intention that any claim require more features than are expressly recited in that claim. Moreover, any components, features, or steps illustrated and/or described in a particular embodiment herein can be applied to or used with any other embodiment(s). Thus, it is intended that the scope of the present disclosure should not be limited by the particular embodiments described above.

What is claimed is:

1. A high-precision laser trigger system comprising:
a stage on which an object is mounted;
a trigger generator configured to generate a trigger signal according to a time-based mode and a position-based mode;
a laser configured to emit laser light when the trigger signal is input;
a motion controller configured to control the stage and the trigger generator; and
a control device configured to identify coordinates of the stage, which places the object in a light-emitting position of the laser in the position-based mode, and transmit coordinate information including the coordinates and a mode change signal for changing a mode between the time-based mode and the position-based mode to the motion controller,
wherein the motion controller is configured to:
control the trigger generator to generate the trigger signal every cycle in the time-based mode,
upon receiving the mode change signal, control the stage to accelerate so that a moving speed of the stage reaches a target speed and locate at a starting coordinate of the coordinates;
switch the mode to the position-based mode when the stage is located at the starting coordinate and control the trigger generator to generate the trigger signal whenever the stage is located at each of the coordinates while moving at the target speed; and
when the stage reaches an end coordinate among the coordinates, control the stage to decelerate upon receiving the mode change signal.

2. The high-precision laser trigger system of claim 1, wherein the motion controller calculates a position error caused by a communication delay using the target speed and a communication delay time and corrects the coordinates.

3. The high-precision laser trigger system of claim 1, wherein the control device identifies the target speed of the stage based on the cycle of the trigger signal and a light-emitting interval of the laser.

4. The high-precision laser trigger system of claim 1, wherein the motion controller identifies a position of the stage based on an encoder signal received from the stage.

5. The high-precision laser trigger system of claim 1, wherein the control device sets an acceleration time during which the stage is accelerated, and a deceleration time during which the stage is deaccelerated to be a multiple of the cycle of the trigger signal.

6. The high-precision laser trigger system of claim 1, wherein the motion controller, after accelerating the stage, controls the stage to move to a next starting coordinate.

7. The high-precision laser trigger system of claim 1, wherein the motion controller performs synchronization in the position-based mode while the stage moves to the starting coordinate.

8. A high-precision laser trigger method performed by a high-precision laser trigger system, the high-precision laser trigger method comprising:
controlling a trigger generator to generate a trigger signal every cycle in a time-based mode;
controlling, upon receiving a mode change signal to change a mode from the time-based mode to a position-based mode, a stage on which an object is mounted to locate at a starting coordinate among coordinates of the stage by accelerating the stage so that a moving speed of the stage reaches a target speed;
switching the mode to the position-based mode when the stage is located at the starting coordinate and controlling the trigger generator to generate the trigger signal whenever the stage is located at each of the coordinates while moving at the target speed; and
when the stage reaches an end coordinate among the coordinates, controlling the stage to decelerate upon receiving a mode change signal for changing the mode from the position-based mode to the time-based mode.

9. The high-precision laser trigger method of claim 8, further comprising, before the controlling of the stage to be located at the starting coordinate, identifying the coordinates of the stage for placing the object at a light-emitting position of the laser in the position-based mode.

10. The high-precision laser trigger method of claim 9, wherein the identifying of the coordinates of the stage includes calculating a position error caused by a communication delay using the target speed and a communication delay time and correcting the coordinates.

11. The high-precision laser trigger method of claim 8, further comprising, before the controlling of the stage to be located at the starting coordinate, identifying the target speed of the stage based the cycle of the trigger signal and a light-emitting interval of the laser.

12. The high-precision laser trigger method of claim 8, further comprising identifying a position of the stage based on an encoder signal received from the stage.

13. The high-precision laser trigger method of claim 8, further comprising setting an acceleration time during which the stage is accelerated, and a deceleration time during which the stage is deaccelerated to be a multiple of the cycle of the trigger signal.

14. The high-precision laser trigger method of claim 8, further comprising, after the controlling of the stage to decelerate, moving the stage to a next starting coordinate.

15. The high-precision laser trigger method of claim 8, wherein the controlling of the stage to be located at the starting coordinate includes performing synchronization in the position-based mode while the stage moves to the starting coordinate.
